(19) United States
(12) Patent Application Publication
(10) Pub. No.: US 2014/0089061 A1
(43) Pub. Date: Mar. 27, 2014

(54) MOBILE DRIVE THRU ORDERING SYSTEM

(71) Applicant: Christopher Joseph VITALE, East Northport, NY (US)

(72) Inventor: Christopher Joseph VITALE, East Northport, NY (US)

(21) Appl. No.: 13/838,092

(22) Filed: Mar. 15, 2013

Related U.S. Application Data
(60) Provisional application No. 61/705,460, filed on Sep. 25, 2012.

(51) Int. Cl. G06Q 50/12; G06Q 30/06; G06Q 20/20

(52) U.S. Cl. CPC G06Q 50/12; G06Q 20/204; G06Q 30/0633
USPC 705/7.41; 705/5

(57) ABSTRACT

At least one embodiment relates to a mobile computing device having a processor programmed to take a plurality of food orders and programmed to aggregate these food orders into a single scannable source of information such as a 2D barcode. There can be a scanner such as a bar code scanner or a near field communicator configured to read this scannable source of information. There can also be a microprocessor in a computing device which is configured to read from the scanner a scanned aggregated order at a point of purchase location, wherein that microprocessor is programmed and configured to de-aggregate an order from this scanned communication. There can also be a transceiver is configured to send this de-aggregated information. There can also be a point of sale computing device 80 having a processor 81 configured to read this de-aggregated information and to ring up a scanned aggregated order to create an order for a purchase.

### CROSS REFERENCE TO RELATED APPLICATIONS

This application is a non provisional application that hereby claims priority from provisional application Ser. No. 61/705,460 filed on Sep. 25, 2012 the disclosure of which is hereby incorporated herein by reference in its entirety.

### BACKGROUND

At least one embodiment is a mobile drive thru ordering system which allows users to remotely aggregate orders, create a single order command and then place this order.

### SUMMARY

At least one embodiment relates to a mobile computing device having a processor programmed to take a plurality of food orders and programmed to aggregate these food orders into a single scannable source of information such as a 2D barcode. There can be a scanner such as a bar code scanner or a near field communicator configured to read this scannable source of information. There can also be a microprocessor in a computing device which is configured to read from the scanner a scanned aggregated order at a point of purchase location, wherein that microprocessor is programmed and configured to de-aggregate an order from this scanned communication. There can also be a transceiver is configured to send this de-aggregated information. There can also be a point of sale computing device 80 having a processor 81 configured to read this de-aggregated information and to ring up a scanned aggregated order to create an order for a purchase.

In at least one additional embodiment, there is a computerized process for processing an order for a restaurant comprising following any one of the following steps, determining an identity of an enrolled users, determining a location of the enrolled use, determining a past history of purchases for the enrolled user, determining a location of a point of purchase, suggesting a purchase to the enrolled user; receiving an order from the enrolled user, wherein the step of suggesting a purchase comprises determining via a microprocessor a likely purchase order based upon an identity of the user, the location of the user, the past purchase history of the user, and the location of the point of purchase an presenting the suggestion to the enrolled user.

In at least one additional embodiment, there is a computerized process for analyzing a quality of a point of purchase location. This process can comprise the steps of identifying a location of a point of purchase, determining a number of potential customers that pass said location of said point of purchase and storing the information in a database; determining a number of registered potential customers that pass the location of the point of purchase, by reading a set of positioning coordinates of the registered potential customers; determining a number of customers who purchase items from the point of purchase by reading a sales log; determining a participation rate using a microprocessor by dividing the number of actual customers by the number of potential customers; offering an incentive for a purchase to a plurality of the registered potential customers; and determining a new participation rate for the customers using the microprocessor, comparing the number of actual customers to the number of potential customers.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a schematic layout of the hardware or system which is one example of the invention;

FIG. 2 is a flow chart with an example of a process for performing the process of the invention; and

FIG. 3 is a view of a housing for the scanner;

FIG. 4 is a view of a 2D barcode screen shot;

FIG. 5A is a view of a screen for placing an order;

FIG. 5B is a view of a screen for selecting a more particular order;

FIG. 5C is a view of a screen for confirming an order selection;

FIG. 6A is a view of a screen for placing an order;

FIG. 6B is a view of a screen for placing a more particular order;

FIG. 6C is a view of a screen for confirming an order;

FIG. 7A is a view of a screen for a 2D barcode;

FIG. 7B is a view of a screen for a NFC transfer;

FIG. 7C is a view of a screen for payment options;

FIG. 8A is a view of a screen for barcode payment options shown in FIG. 7C; and

FIG. 8B is a view of a screen for NFC payment option shown in FIG. 7C;

FIG. 9 is a block diagram of a network for use with a second embodiment;

FIG. 10A is a block diagram of the components of one of the devices shown in FIG. 9;

FIG. 10B is a block diagram of the components of another one of the devices of FIG. 9;

FIG. 11 is a block diagram of the databases shown in database server 202;

FIG. 12 is a flow chart for a process for a first embodiment of the invention;

FIG. 13 is a flow chart for a process for a second embodiment of the invention;

FIG. 14 is a flow chart for a process for a third embodiment of the invention;

FIG. 15 is a flow chart for a process for a fourth embodiment of the invention;

FIG. 16 is a flow chart for another embodiment of the invention;

FIG. 17 is a flow chart for another embodiment of the invention; and

FIG. 18 is a flow chart for another embodiment of the invention.

### DETAILED DESCRIPTION

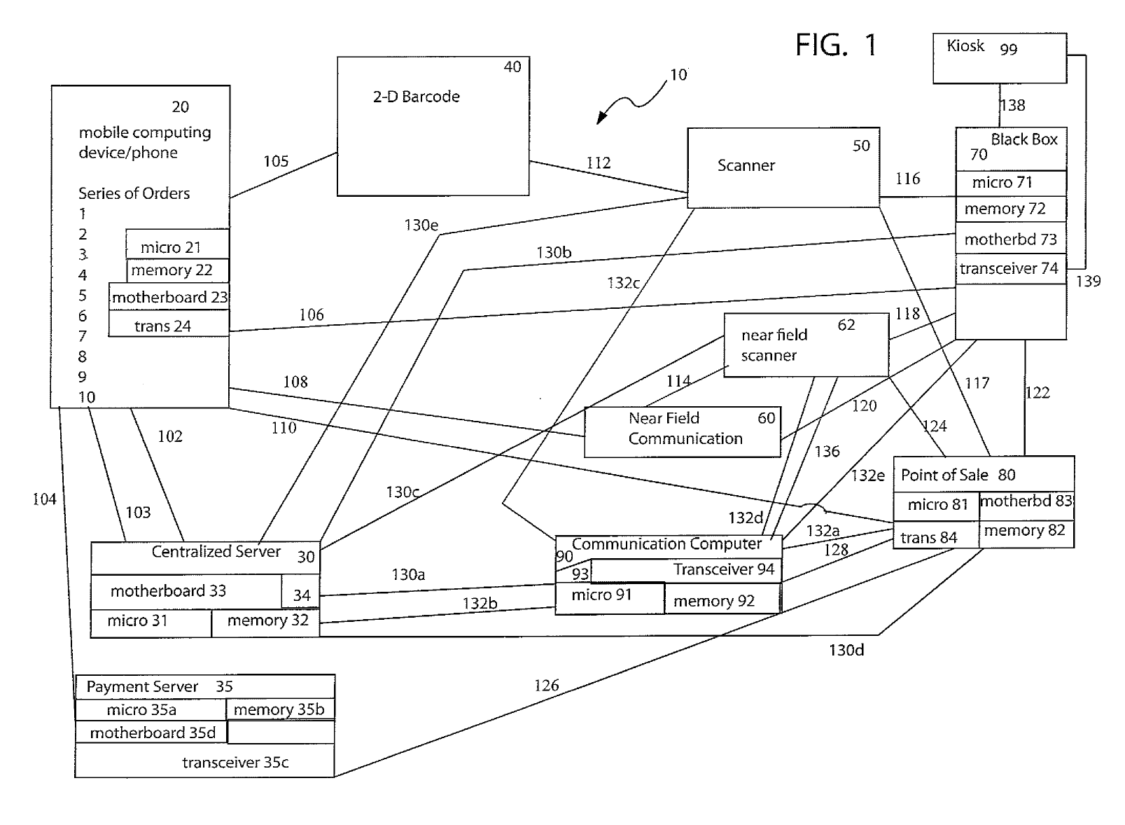

FIG. 1 shows a system and process for communicating separate orders to fast food restaurant over a computer network. This system 10 includes a mobile computing device such as a portable telephone such as a cell phone 20. A user can then create and take a series of orders on this phone. The user can input a series of orders on the phone and enter these orders into the system. This type of phone can run an application which can be configured to sync or communicate with a centralized server 30 in step 102 to keep the information on the mobile computing device/phone up to date. The information displayed on this telephone (mobile phone or computing device) can be an array of fast food orders such as an order for a drink, food, or other type of service. For example, a single order can include an order for a medium coffee, having cream and sugar. Each item or element of the order can be assigned an alphanumeric code or a number such as a three digit number. While a three digit number is used as an example, any alphanumeric digit number can be used as well such as a four digit number, a five digit number, a six digit number a twelve digit number or even a 16 digit number. While any number can be used, an example is provided below which is for a three digit number.

For example, since the order for a medium coffee with cream and sugar includes three separate elements, this would result in the following set of numbers: 132, 642, and 823 with the number 132 signifying a medium coffee, the number 642 signifying cream, and the number 823 signifying sugar. The next order, for example order number two (2) could be for a cheeseburger. That could be coded as 963, for example wherein that particular number would signify a cheeseburger. If the order was for a cheeseburger with onions, then the order would be 963, 139 where the code 963 would be for a cheeseburger, while the number 139 would be for onions if the standard order for cheeseburger did not already come with onions.

Each order could be taken by the user in step 103 with the mobile phone or other mobile computing device for multiple parties. Next, the person could also communicate with these parties placing the order, and indicates that they pre-paid for their order. This would be through a communication with the parties involved and with payment server 35 in step 104 as well. Each person placing the order could then pre-pay for their share of the order through payment server 35. This way the person taking the order would not be shortchanged when it came time to pay the bill. For example, the payment server may collect all payment information and send it to the end user. The payment data may be communicated through the NFC (Near field communicator) to the black box 70 or, directly to a point of sale 80 or through a 2D barcode scanner 50, to the black box 70.

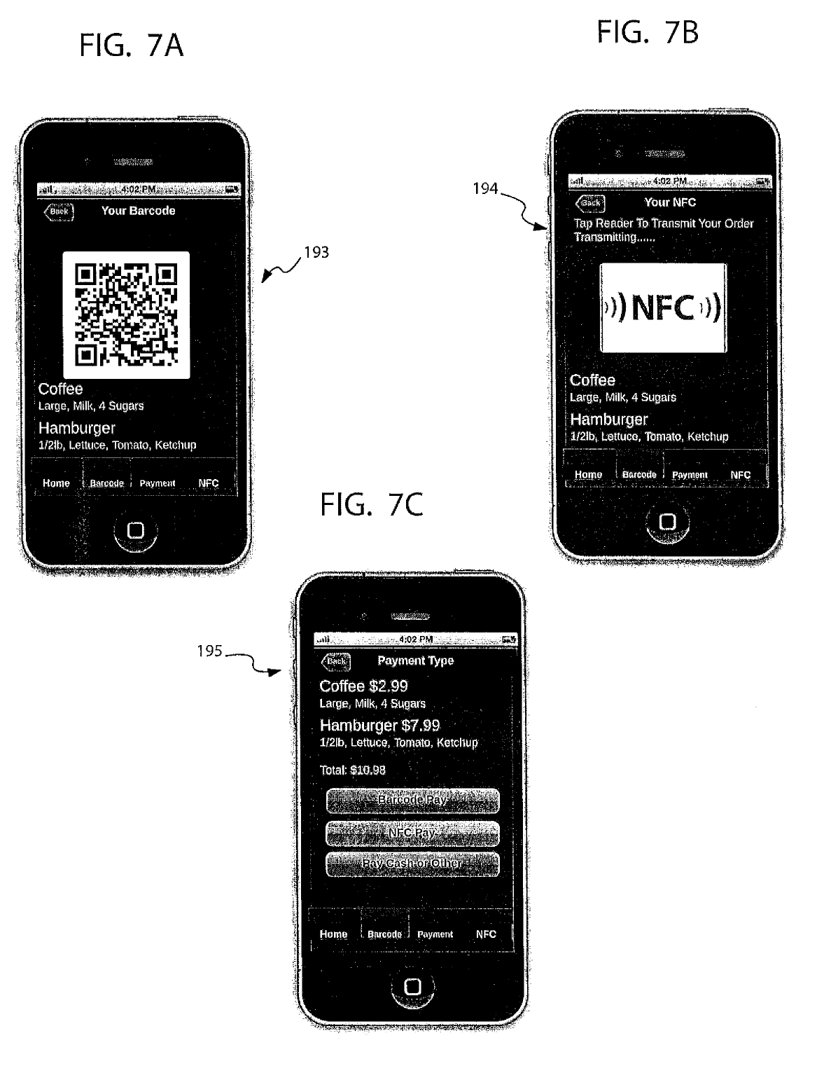

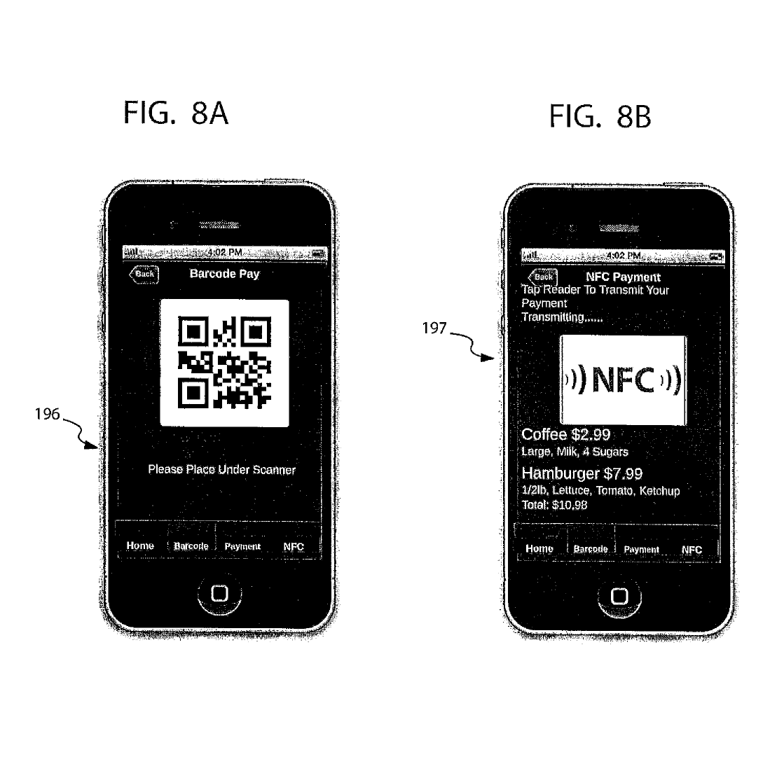

When the order is placed, there can be a button on the mobile phone's screen to pay (See FIG. 7C). This may generate a payment barcode (See FIG. 8A) and communicate let's say a “gift card” to the payment collector. They will scan the code and payment will be made. (It's basically a 16-digit credit card number encoded as a 2d barcode. Alternatively, the user could send the payment through NFC reader 62 at the payment window to send payment (See FIG. 8B). If the enclosure is built at the ordering menu at a drive thru another NFC reader and scanner will be required at the payment/order receiving window. It will still have to communicate with the payment server but the information to the POS 80 from the mobile computing device or phone 20 will come from the mobile device 20 and trigger the POS 80 to hit the payment server 35 to authenticate.

For example, at a fast food location, the user can open the application, and purchase a $20 dollar gift card. When the user buys a coffee, for $3.00, that user can click pay on the application. The gift card barcode comes up, the cashier scans the barcode, or alternatively it is scanned at the drive thru. The POS system 80 takes the scan, communicates with payment server 35, receives payment, then payment server 35 tells the mobile phone 20 that the purchase has been paid and the system subtracts $3.00 telling the user that they have $17.00 left on the electronic gift card. This computation is achieved by the mobile computing device 20 and recorded in central server 30 or alternatively recorded in central server 30 and updated to mobile computing device 20.

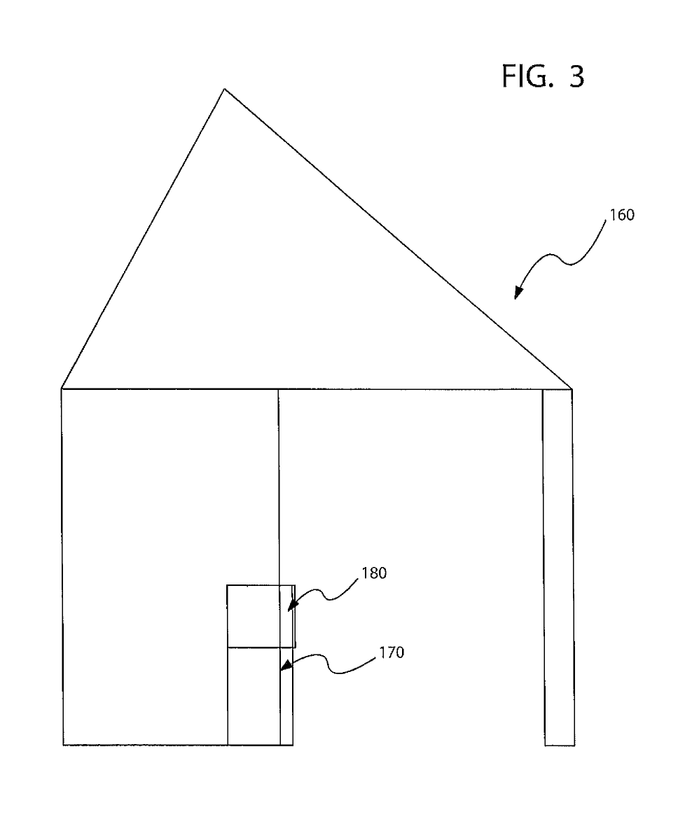

Therefore, physical payment information is communicated directly however both the POS 80 and Mobile device 20 are tied to payment server 35 for authentication. Alternatively this gift card can be scanned by the scanner in the enclosure of the NFC reader (See FIG. 3) as well.

This information for every order, as well as optionally the payment information, can be coded into a single communication. This single coding of the entire order and payment can be created in the form of either a 2-d barcode in step 105, a direct transmission in step 106 or a coded communication via near field communication in step 108. Alternatively, this information could be sent by electronic transmission directly to point of sale 80 in step 110. This coding can be created either internally by mobile computing device 20 or by central server 30 and then communicated back to mobile computing device or phone 20 for storage.

Once the order is recorded, when a person drives into a drive thru area of a fast food restaurant, that person can then place their exact order by either scanning their 2-D barcode 40 from the screen of their phone using a scanner 50 in step 112, or send a near field communication 60 to a near field communicator (NFC reader) 62 in step 114 or send this near field communication directly to a black box 70 in step 120 wherein the black box would then have the scanner or NFC reader built in. Near field communicator 62 can then send this communication on to black box 70 in step 118 and 2D scanner 50 can send this information on to black box 70 in step 116 as well. Alternatively, 2d Scanner 50 and NFC scanner 62 can send this information onto POS system 80 directly as well.

This type of communication shown in steps 106, 116, 118, and 120 is an aggregate of all of the compiled fast food orders is uploaded in to black box 70. Black box 70 acts as a de-aggregator and translator for the codes for the order. First, black box 70 receives the aggregated information and then either transmits this information, and then de-aggregates this information. Alternatively, black box 70 can de-aggregate the numerous orders and their associated codes and then translate these codes into usable codes for the point of sale system 80.

As indicated above, POS system 80 can include all of the software for black box 70 so this POS system can receive this information in either step 117 (communication from scanner 50 to POS 80) or step 124 (communication from NFC scanner 62 to POS 80) as well.

In step 122, black box 70 communicates this information to point of sale system 80. Point of sale system 80 then rings up the sale. At that point, the person placing the order can pay for this sale using either cash, credit card, or a through a computerized payment such as through payment server 35 via step 126. In this case, the system can communicate payment through NFC or 2D barcode. All of which maybe be direct through step 110 or could possibly go through step 116, 106, 118 or 120. The mobile computing device or phone 20 is connected to a payment service 35 to authorize the transaction and take the money from the accounts and transfer it to the POS 80. This order information can then be stored and recorded in at least one database such as in the database in communication computer 90 in step 128.

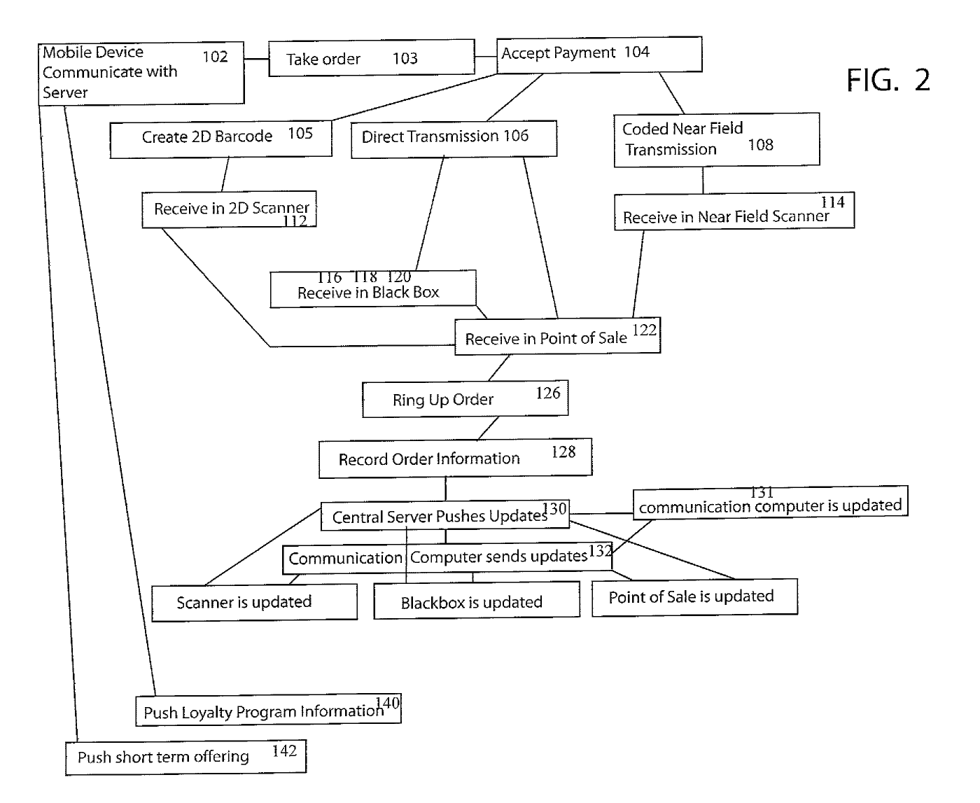

To keep the computerized system updated with the proper array of products and pricing, the different computerized systems can be periodically updated via communication with one or more centralized servers. For example, central server 30 can update communication computer 90 in step 130a, black box 70 in step 130b, near field communicator 62 in step 130c, point of sale 80 in step 130d, and scanner 50 in step 130e. Communication computer 90 can be an on-site (on the site of the fast food restaurant) or be a centralized server servicing multiple fast food sites. This computer 90 can then communicate directly with centralized server 30 which can be a centralized server for a fast food restaurant which may include at least one database which stores all of the information relating to products, pricing, and offers for each fast food restaurant in step 130 or the same can occur with centralized server in step 132 (See FIG. 2).

Communication computer 90 can also communicate with centralized server 30 on a periodic basis so that this communication computer stores a localized database of information of products and prices for either that store or several regional stores.

Communication computer 90 can also optionally update the following components: Scanner 50 in step 132c, near field communicator or NFC reader 62 in step 136, black box 70 in step 124 and point of sale 80 (see step 132a). For example, communications computer can update the other components such as point of sale 80 in step 132a, centralized server 30 in step 132b, scanner 50 in step 132c, near field communicator 62 in step 132d and black box in step 132e.

Thus, this communication computer 90 can also serve to monitor how all of the hardware such as black box 70, scanner or NFC 62, or scanner 50 or point of sale (POS) system 80 are functioning. If the point of sale system (POS) 80 is locked down, then the black box 70 can handle all of the necessary communications in order to achieve the process shown in FIG. 2. Black box 70 can also serve as the system to track transactional data as well.

The system allows for an aggregation of the orders, a centralized payment of the orders and a quick uploading of the order information so that a single person can place multiple orders through a drive through or walk up payment area at a single time. This rapid communication of large orders allows servers to begin preparing these orders in a faster manner allowing a greater volume of orders and/or people to clear through the restaurant in a faster manner. In addition, because this order taking is conducted using a computerized device such as a mobile computing device 20, the orders can be pre-screened and selected so that once the information is transferred, the person placing the order can insure that the order is correct before they receive their food.

This system can also gather and store information about the purchasing habits of different users. This includes all metrics of transactional sales data. Each user can be then enrolled in a loyalty program wherein previous purchases by each user are recorded either locally in communication computer 90 or in centralized server 30 so that if the users can obtain either additional free meals, reduced prices, or coupons through this server. In addition, the information stored about the purchasing habits of each user can be used for future business modeling as well. This system can then via either centralized server 30 or via communication computer 90 push loyalty program rebates or coupons in step 140 (see FIG. 2) to communicate with participating users on their mobile computing device.

Furthermore, the system can be configured to provide a mobile short term offering to users to allow store owners to clear out inventory. For example, these store owners could provide a late night offering of select products that would otherwise be thrown away for a reduced price. For example, in step 142, this information could be pushed from centralized server 30 or sent directly from communication computer 90, or sent from communication computer 90 to centralized server 30 and then on to the user's mobile computing device or mobile phone 20. In short the computerize system and process provides:

1) a mobile order taking system which aggregates multiple orders into a single identifiable transmission (barcode, near field coded transmission, electronic communication)

2) a de-aggregation of this order and translation of this order into a point of sale system;

3) automatic ringing up of the order based upon this communication;

4) optional automatic payment of this transaction using a payment server;

5) a rewards program to reward loyalty among consumers such that every time an enrolled party visits, their trip is registered;

6) a customer demographic order tracking system to track which users are purchasing which items; and

7) a mobile short term offering program to provide for example late night sales offerings to individuals. There can also be a time tracking system from when an order is placed and when the payment is made. This system can also include a customer experience survey as well.

This computerized system can store in either communication computer 90 or centralized server 30 the demographic profiles of the users as well. This can be achieved by defining a username, a password for the app, as well as some optional questions and answers upon registering. The customer can be asked their birthdate so that the user can be provided free products on their birthday. In this way, the store owners can determine which type of customer is buying which type of products. Centralized server 30 can include elements such as a processor or microprocessor 31, a memory 32, and a motherboard 33. This device can also include a transceiver 34 for communication with other objects. In addition, mobile computing device 20 can include a microprocessor 21, a memory 32, a motherboard 33 and at least one transceiver 34 as well. The other computing devices also include similar components such as mobile computing device or phone 20 includes a microcontroller 21, a memory 22, a motherboard 23 and a transceiver 34.

Payment server 35 can include a microcontroller or microprocessor 35a, a memory 35b, a memory 35b, a transceiver 35c, or a motherboard 35d.

Black box 70 can be a form of proprietary hardware or it can be in the form of a standard computer server. For example, Black box 70 can include a microcontroller 71, a memory 72, a motherboard 73, and a transceiver 74. Pont of sale 80 can be in the form of a computing device as well wherein this point of sale system can include a microcontroller 81, a motherboard 83 memory 82, and a transceiver 84. Communication computer 90 can be in the form of a standard computing device such as a personal computer (PC) or a server and can include a microprocessor 91, a memory 92, a motherboard 93, or a transceiver 94.

For these above listed components, the term microcontroller can also refer or be a microprocessor such as microprocessor 21, 31, 35a, 71, 81, or 91 which can be any suitable microprocessor known in the art such as a Intel or AMD brand microprocessor. The memory such as memory 22, 32, 35b, 72, 82, or 92 can be any suitable memory such as random access memory (RAM) and/or read only memory (ROM) and can be in the form of a solid state memory. With these designs, the different memory components 22, 32, 35b, 72, 82, 92 can read or put into their associated processor 21, 31, 35a, 71, 81, or 91 the information in the form of steps shown in FIG. 2 to complete this process. The associated transceivers 24, 34, 35c, 74, 84, 94, allow for communication between these different computing devices in any suitable manner such as through wired communication such as using Ethernet lines such as for example Cat 5 lines or Cat 6 lines, through wireless communication such as 802.11x type communication, through cellular communication, or through Bluetooth or any other suitable type of communication.

Motherboards 23, 33, 35d, 73, 83, and 93 allow for communication between the components in one of the computing devices. The information relating to the rewards programs, the loyalty programs, and the mobile short term offering system is stored in a database such as either in communication computer 90 or in centralized server 30. This database can be stored in the associated memory 92 or 32 and then searchable through the use of queries via the use of an associated processor 31 or 91.

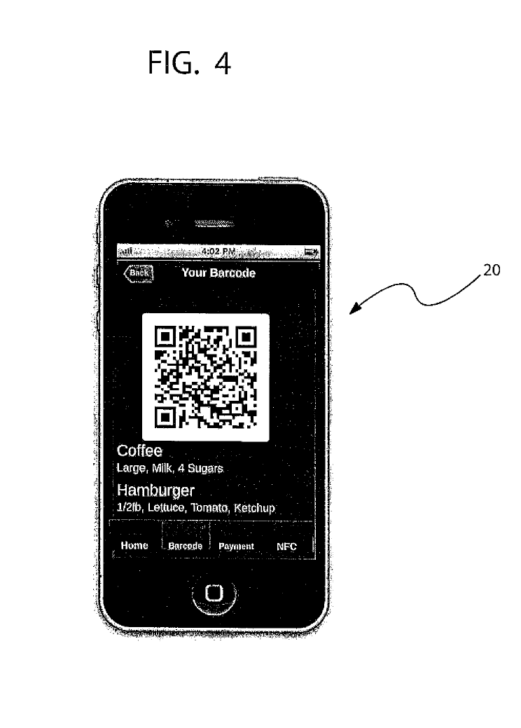

FIG. 3 is a view of a payment section for a drive thru 160. For example, there is housing 170 which is shown housing a scanner 180 disposed inside. This housing can form a closed container so that the integrity of the scanner 180 is not disturbed. The positioning of the scanner at a first window in for example a drive thru allows a user to present a 2D barcode as shown in FIG. 4 to place an order, and even pay for that order.

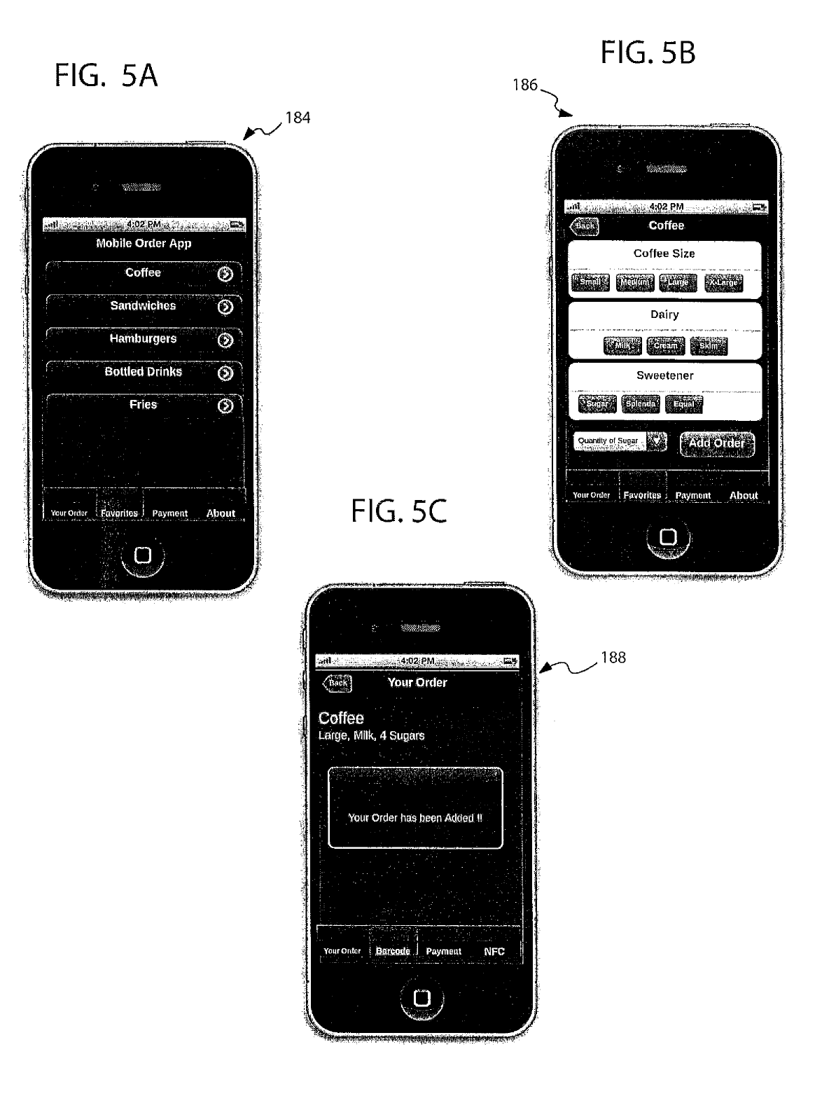

FIG. 5A shows a screen shot of a first order offering on a mobile phone such as mobile phone 20. This includes a screen 184 which includes an offering for different types of food including coffee, sandwiches, hamburgers, bottled drinks and fries. The user selects for example a coffee in FIG. 5B shown by screen 186 which allows the user to select the size of the drink, whether they want to add any dairy as well as any sweetener. Once the order has been placed it can be stored or recorded in centralized server 30, or alternatively rung directly through black box 70 onto POS system 80 or directly through POS system 80 if the user is recording this order in the store via a kiosk. Once the order is recorded, FIG. 5C shows a screen 188 where the order has been confirmed and added to the database as well as to the queue of orders.

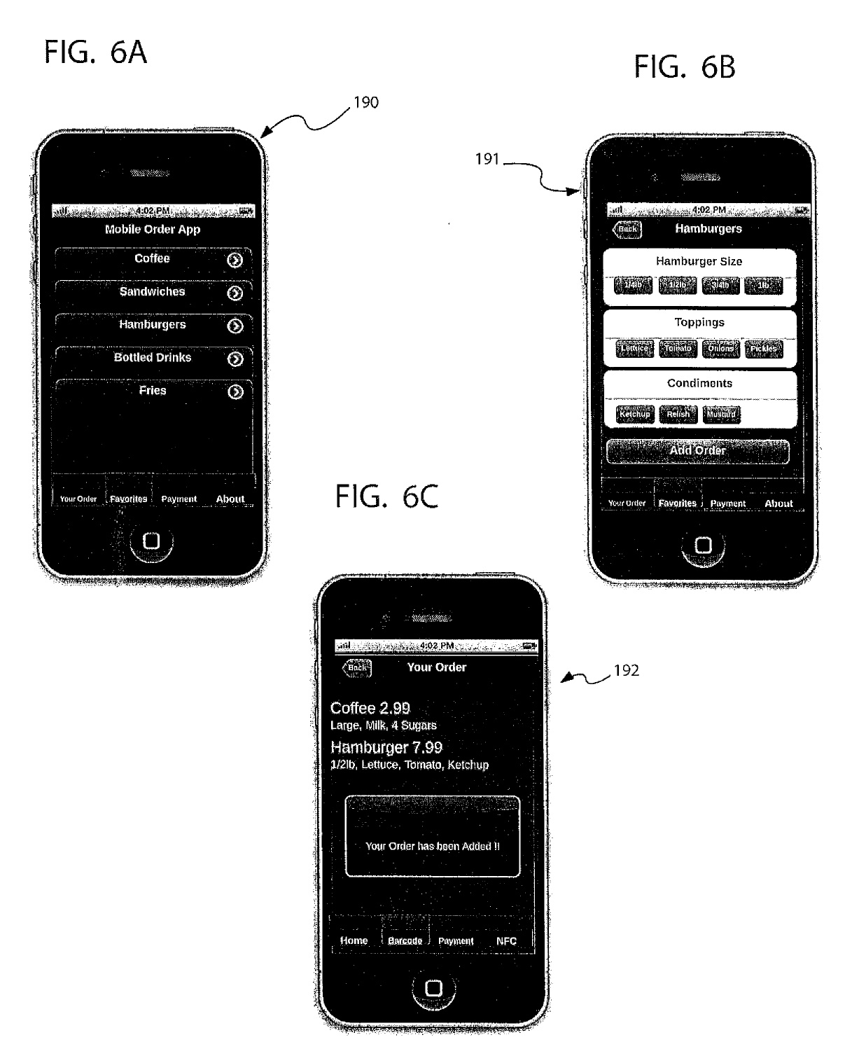

FIG. 6A shows another screen 190 which is similar to screen 184 wherein the user is now ordering a hamburger shown in FIG. 6B. FIG. 6B shows a screen 191, wherein the user orders the size of the hamburger, the toppings, as well as the condiments for that order. Once the user has customized his order it is recorded into the database such as in database in centralized server 30. Alternatively, if the user is in a store and using a kiosk, the order is first recorded in black box 70 and then to POS 80 or directly, or recorded in POS 80 directly if POS 80 includes the necessary software as black box 70. Ultimately, this information is then forwarded onto centralized server 30 as well.

Next FIG. 6C shows a screen 192 wherein the customer's order including both the order from FIG. 6B as well as the order from FIG. 5B are recorded.

FIG. 7A shows the creation of the 2D barcode for the order of coffee as well as the hamburger in screen 193. This 2D barcode is useful if the user is communicating via scanner 50. Alternatively, if the user is communicating via NFC reader then FIG. 7B shows the indication of transfer of information via NFC reader 62 in screen 194. FIG. 7C shows screen which discloses a screen 195 indicating the order total as well providing the user with the method of payment such as with a barcode pay option, a NFC pay option or a cash payment option as well.

FIG. 8A shows a barcode payment selection via screen 196. FIG. 8B shows a NFC payment selection screen 197 as well.

In addition the term “2D barcode” can also refer to a 2-D QR Barcode or 2D Data Matrix Code 40 which is shown in greater detail in FIG. 4.

Ultimately, this system and process can work in environments where a purchaser can place an order and then a clerk builds and retrieves the order for the person. For example, this system can be used at a Deli Counter, a Butcher, a Meat Market, a Fish Market, and Bakery and movie theater concession etc. The users of this system could then skip a line, avoid taking a number, for a standalone order with the butcher/deli counter etc. This system can also be used for non-food ordering types of service such as with a drycleaner, or movie theater.

In addition this system can also be used in a bar. So that patrons are not waiting endlessly at a bar the system can be used to aggregate drink orders and then present them as a single order to be serviced at one time.

Furthermore, this system can also have a kiosk 99 built into restaurant table or tables in any food environment where you place the order on your phone 20. Kiosk 99 can contain any one of a scanner 50 and/or NFC reader. 62. Kiosk is hooked up to the table so that users can send their order directly to the kitchen by tapping the mobile computing device or phone 20 on the reader in the table or scanning the order in the kiosk 99. This step can occur either in step 138 wherein the information is sent to black box 70 step 139 where the information is sent to POS 80. Furthermore, this system can be used with any store that can have runners in it. When a user walks into the store, a runner, which is a person who is an order taker carrying a portable scanner, requests the order from the user. The user can then scan his or her order and then the runners can get what the user needs. This system can also be used with car washes, so that the user can pick what they want. With this system a person greats the user, scans the services you need, and the user pays immediately. The kiosk can be used anywhere an order pickup or any type of information that can be prebuilt and conveyed prior to verbally communicating what you need.

Thus there is shown a computing system comprising a mobile computing device 20 having a processor 21 programmed or configured to take a plurality of food orders and programmed or configured to aggregate these food orders into a single scannable source of information such as a 2D barcode 40. There can also be a scanner such as a bar code scanner 50 or a near field communicator 62 configured to read this scannable source of information. There can also be a microprocessor such as microprocessor 71 in a computing device 70 which is configured to read from the scanner a scanned aggregated order at a point of purchase location, wherein that microprocessor 71 is programmed and configured to de-aggregate an order from this scanned communication. There can also be a transceiver 74 is configured to send this de-aggregated information and a point of sale computing device 80 having a processor 81 configured to read this de-aggregated information and to ring up a scanned aggregated order to create an order for a purchase.

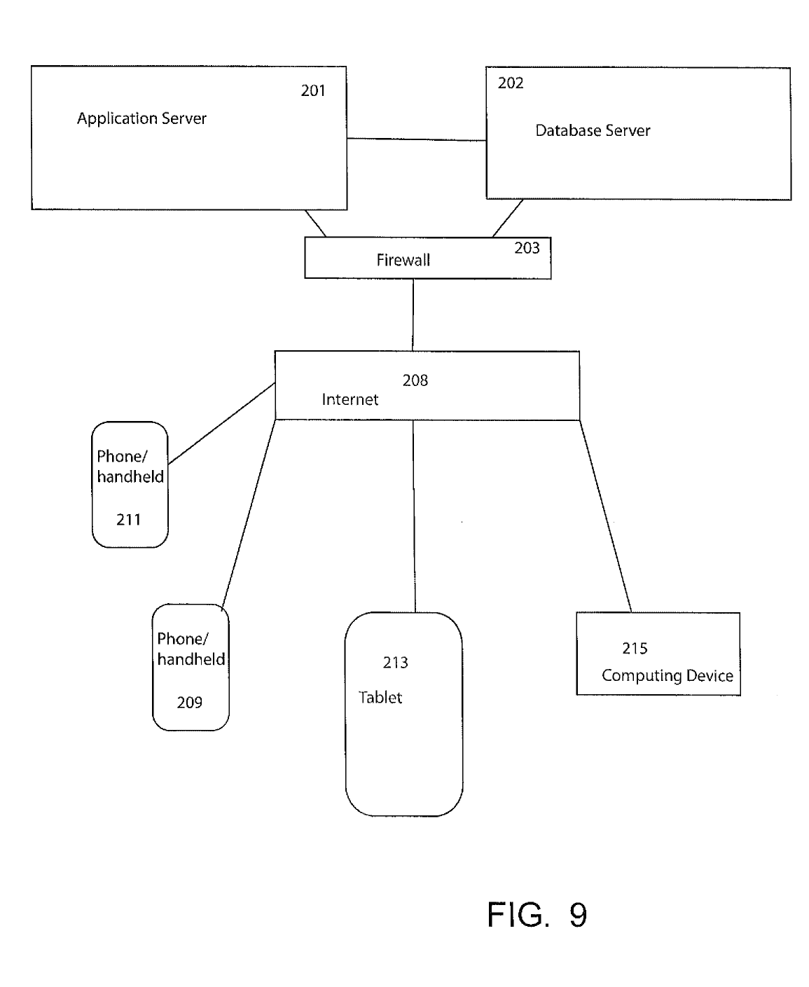

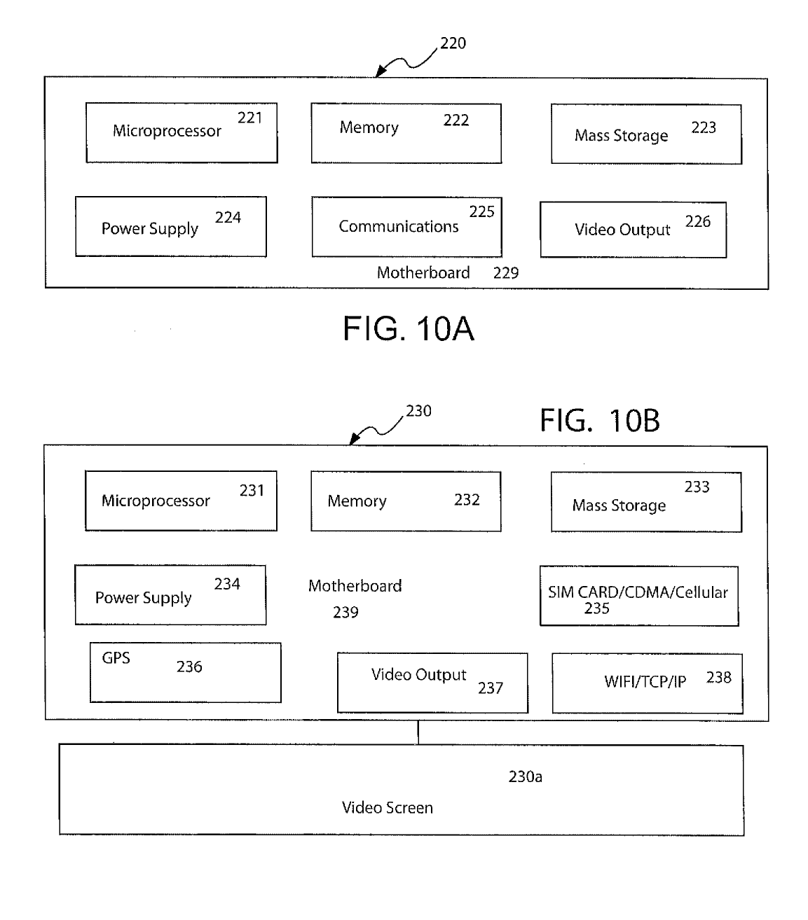

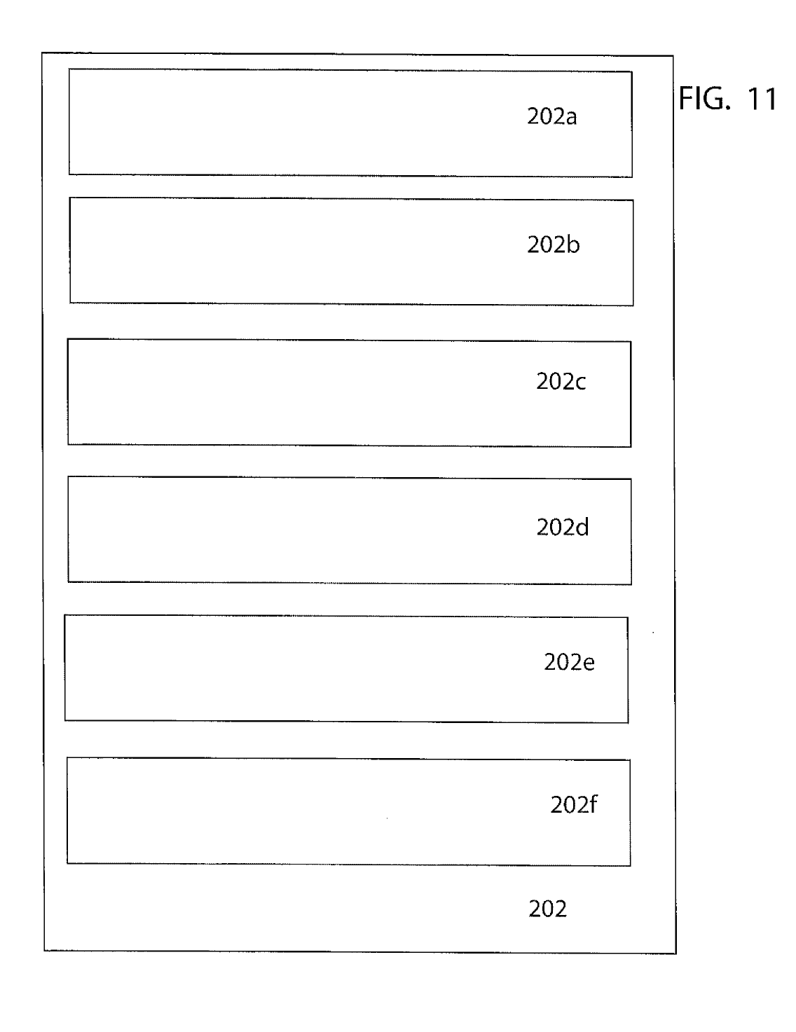

FIG. 9 is a block diagram of an alternative embodiment of a system associated with the invention. For example, there is shown a computer network comprising the internet 208 which is coupled at one end to a firewall 203. Behind the firewall are at least one application server 201 and at least one database server 202. Alternatively both the application server and the database server can be housed in one device. The application server is configured to run the processes and features disclosed in FIGS. 11-18. The database server 202 is configured to house the data information which is used in the processes disclosed in FIGS. 11-18 as well. The electronic components associated with the database server 201 and the application server 202 are disclosed in FIG. 10A. Servers 201 and 202 can be used as an alternative to centralized server 30 and payment server 35, but still be configured to operate with the other components shown in FIG. 1 such as kiosk 99, black box 70, point of sale 80, scanner 50, scanner 62 and communication computer 90. Alternatively much of these transactions and processing can occur simply using the servers 201 and 202 as well as at least one mobile device such as a phone 20, any one of phones 209 and 211.

In addition, there is also shown a plurality of remote devices such as phones 209 and 211. These remote devices can be in the form of communication devices which include communication elements which either alone or in combination with other components are configured to communicate through an interface such as a common gateway interface (CGI) with the communication server and the database server. Electronic components associated with this type device are shown in FIG. 10B.

In addition, in communication with the internet 208 are a plurality of different computing communication devices, such as a tablet computing device 213 or any other type of suitable computing device 215. Computing device 215 can be in the form of a personal computer suitable for creating an online order to a web page.

FIG. 10A shows a block diagram of the components of any of the servers 201 and 202 of the embodiment of FIG. 9. For example, there is shown a microprocessor 221, memory 222, a mass storage 223, a power supply 224, a communications device 225, and a video output 226. Microprocessor 221 is configured to run the program associated with the process shown in FIGS. 11-18. Memory 222 is a RAM type flash memory which is used to upload the program associated with the process shown in FIGS. 11-18 so that microprocessor 221 can access the set of instructions in memory and carry out or perform these sets of instructions. Thus, microprocessor 221 is configured to perform the steps or features outlined in FIGS. 7-14. Mass storage 223 is configured to allow the program to reside in its memory banks. With instructions from microprocessor 221, the information from mass storage 223 can be loaded into memory 222 such that microprocessor 221 can perform the steps in a RAM type memory. RAM memory 222 can be any type of suitable flash or EEPROM type memory. Mass storage 223 can be any type of suitable mass storage device, such as solid state memory or older style platter based hard drives.

These components are powered by a power supply 224 and can communicate to outside components via a communications module 225. Communications module is configured to communicate via any suitable protocol such as but not limited to TCP/IP. There is also a connection and hardware to output video via video output 226. All of these components can be coupled together such that they receive power from power supply via motherboard 229. In addition, all of these components can communicate with each other through communication lines on motherboard 229 as well.

FIG. 10B relates to the electronic components that are associated with the portable computing devices such as the phone 210, the tablet 212 or the stationary or portable computing device 114. These components 230 include a microprocessor 231, a memory 232, a mass storage 233, a power supply 234, a communications/identification card 235, a GPS 236, a video output controller 237, and a WIFI or other type of communications controller/card 238. All of these components are coupled to motherboard 239 and can communicate power as well as information with each other through motherboard 239. In addition, coupled to motherboard 239 is a video screen 230a which allows for a readout of information which may be stored on servers and 101 and 102 which detail information about remote devices 209 and 211.

FIG. 11 is a block diagram of the types of databases/tables that can be present on database server 202. These databases 202a-202f can store information about users as well as additional relevant information useful for assisting users in making purchases. For example, there is a first database/table 202a which can include useful weather information in different locations. In that way, this useful weather information can be accessed so that it can be used to suggest particular meals or purchases for a user. A second database/table 202b can be used to store information about the user such as the user's demographics. These demographics can be age, sex (male/female) height, weight, etc. Next, database/table 202c can include information about the user's past purchase history. This past purchase history can include longtime purchase history and purchasing patterns as well as recent purchase history as well. For example, if a user purchased an egg sandwich for breakfast, the system would store this recent purchase in database table 202c. This information could then be accessed to determine which products to market to that consumer based upon this recent purchase history. Alternatively, not so recent purchase history can also be used to track the user's favorite purchases so that the system could also push marketing information to the user based upon the users tracked favorite purchases. Another database table 202d can include the location of the user. This information is useful to position the user relative to points of purchase. In that way if the user is approaching a point of purchase of interest, the system can push additional marketing materials or price incentive materials such as coupons to the user to entice the user into making a purchase. Next, a database 202e relating to the likely destination of the user can also be used. This database can store information about the travel destination of the user so that if the user is travelling towards a particular destination, the system can push marketing materials to the user to entice the user along the route of the user until the user reaches his/her destination. In addition, another database table 202f information about the location of stores or points of purchase. The location of these stores or points of purchase is advantageous because of a user is approaching a store and the location of the user begins to match or approach the location of a store, the system can push marketing information to that user to entice the user to make a purchase in that store.

Thus, microprocessor 221 of application server 201 can access this information stored in database server 202 in these databases to cross reference this information to create useful information to assist users in purchasing products such as food from a nearby establishment.

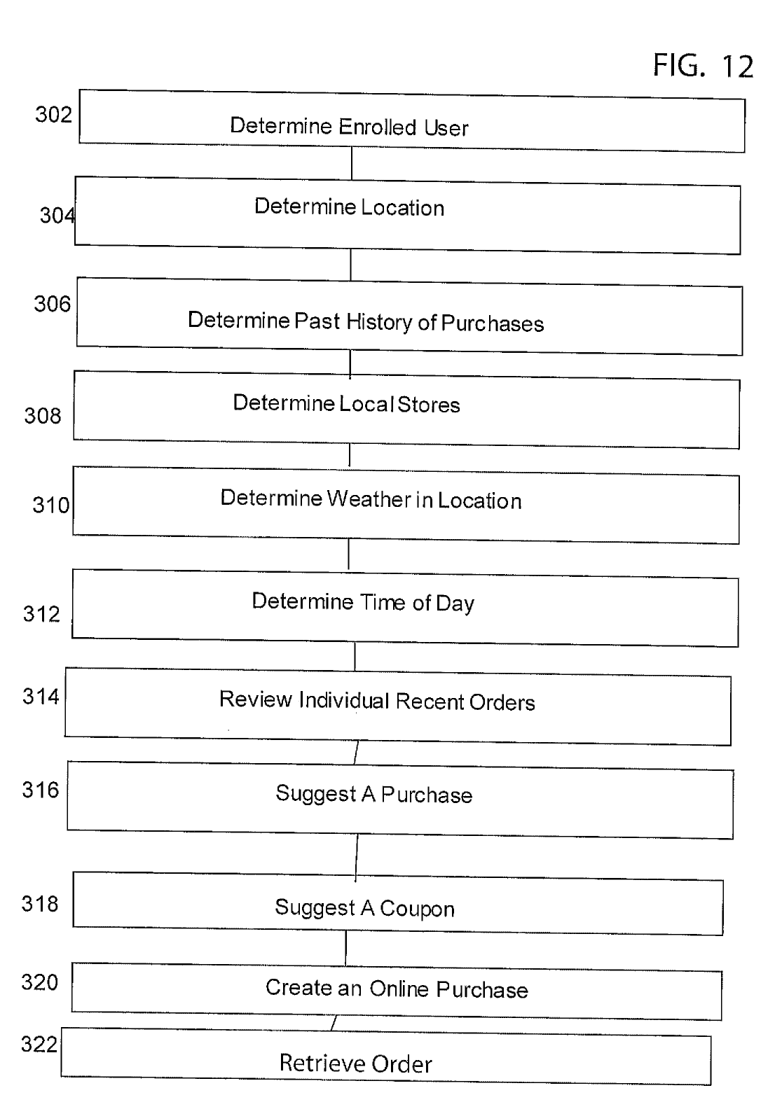

FIG. 12 shows another embodiment of the invention wherein there is shown a process for presenting potential purchase orders based upon weather and other environmental factors. For example, this process can be performed by microprocessor 221 on application server 201, or it can be performed by microprocessor 231 in the mobile telephone/computing devices 209, 211, 213, or stationary computing device 215, or in the processor 21 of mobile computing device 20 which is substantially similar to computing devices 209 and 211. If these determinations are performed locally on the portable or mobile computing devices then these mobile computing devices have the program installed locally in their memory or downloaded periodically into their memory.

The process starts in step 302 wherein the system determines the identity of the enrolled user. This can occur with the system identifying the portable communication device such as device 20, device 209, device 211, device 213 or device 215. This can occur by the user logging in to the system, or by the system identifying the component either through a MAC address, an identity chip in the device such as a SIM or GPRS card or any other identifying information. If the remote computing devices include an “app” downloaded to this mobile computing device, then, whenever the user opened the “app” or powered up the device, the system would receive an indication of the identity and availability of the user. Once the identity is established, the location is also determined in step 304. This location can be determined using a GPS module such as GPS module 236 in any one of the computing devices 20, 209, 211 215 etc. Next, in step 306 the system determines past history of the purchases of the user. This can occur by the system accessing database server 202 and accessing the databases stored on the database server to retrieve this information. Next, in step 308 the system determines the location of local stores near the user. While individuals can sign up for this system, local stores can also sign up for this system as well. Therefore, the identity of these local stores, the location of these local stores, the menus, their prices can all be uploaded into the system, and stored in a database in database server 202.

Next, the system determines the weather in the location of the user and also determines 1) whether there will be any future weather changes, and 2) if there has been a recent change in weather as well, such as recent rise in temperature, a recent drop in temperature, the change precipitation, wind, or any other environmental factor. To determine this information Application server 201 and/or database server 202 can communicate with a weather forecasting service which provides past, present and future weather information to the system. This information can then be uploaded into database server 202, in for example table/database 202a.

Next, in step 312 the system determines the time of day. The time of day's important because it can influence the type of purchases a user might make. For example the user might determine to purchase a breakfast meal if the time is between 6:00 AM and 10 o'clock A.M. Alternatively, if the time is between approximately 10:00 AM and 3:00 p.m. the user may determine to purchase a typical lunch type meal. If for example, the time of day is between 4 o'clock and 8:00 PM then, the user might determine to purchase a typical dinner type meal. The system can determine the time of day for the user by determining the location of the user and also use this information against standard time schedules or adjust based upon a clock or timer in the servers 201 or 202.

Next, in step 314 the system would review the individual recent orders of the user. For example, if the user ordered a large breakfast meal, just recently, such as with the last two hours, the system may use this recent purchase to influence type of purchase the user might wish to make. Alternatively, if the user purchased a very light meal, then the system might determine that the user might be hungry, and wished purchase a large meal next.

Next, in step 316 the system can determine which type of the purchase the user might wish to make and then suggest a purchase. For example, based upon the past history of the purchases in step 306, which includes all of the past purchases, the system is configured to determine that the user has particular favorite orders. In addition, the system can also factor in weather information in the location of the user to determine the type purchase the user may wish to make. For example, if it is a particularly hot day the user may wish to purchase ice cream, or an iced tea. Alternatively, if it is a cold day, the user may wish to purchase a warm drink such as coffee, hot chocolate, hot cider, soup, or any other type of hot drink or meal. Additionally, the system can also determine if there has been a recent rapid weather change. For example, the system would look at the temperature over a time range in a particular location to determine the change in temperature of that location across the period of time such as for example two hours, four hours, six hours, 10 hours, 12 hours, or more.

Alternatively, the setting could be made for any other approximate time or time range that is suitable to determine a rapid weather change. The system is also configured to determine that based upon the time of day the correct type of purchase that the user may wish to make. The suggestion to make a purchase can be in the form of a text, an email, an electronic notification to an “app” installed on the mobile computing device, an SMS message, a telephone call or any other type of suitable notification.

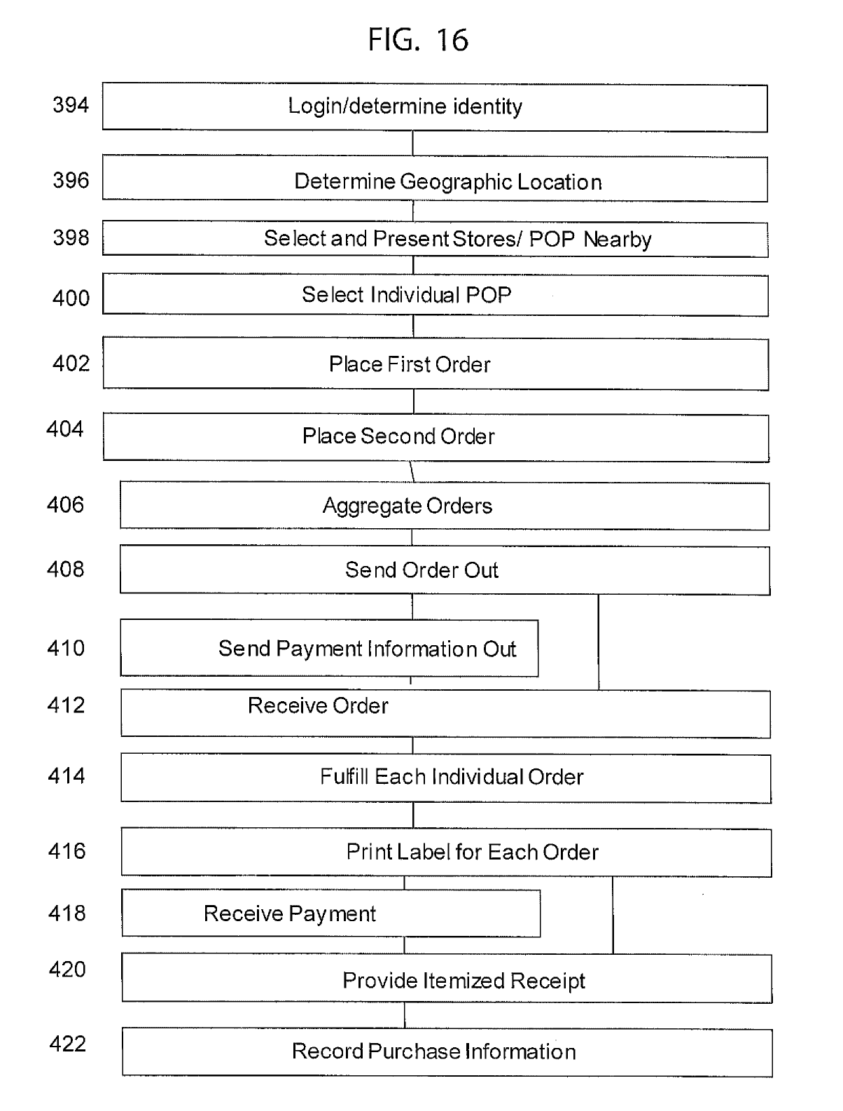

If upon suggesting a purchase, in step 316 the user does not make a purchase within a predetermined time limit, the system can also then suggest coupon in step 318 for a particular meal or a particular purchase. The user can then either after the suggested purchase or the coupon, create an online purchase in step 320, or ignore or refuse the order. The online purchase can be performed by the user selecting the itemized meal that the user wishes to purchase, sending this order to the point of purchase location, and uploading payment information to that point of purchase location such as to black box 70, or alternatively to server such as application server 201. Next, in step 322 the system can retrieve the order either by having a black box 70 or point-of-sale location 80 download this information from a server such as application server 201, centralized server 30, or payment server 35 and then create the order such as disclosed in the steps 402-422 in FIG. 16.

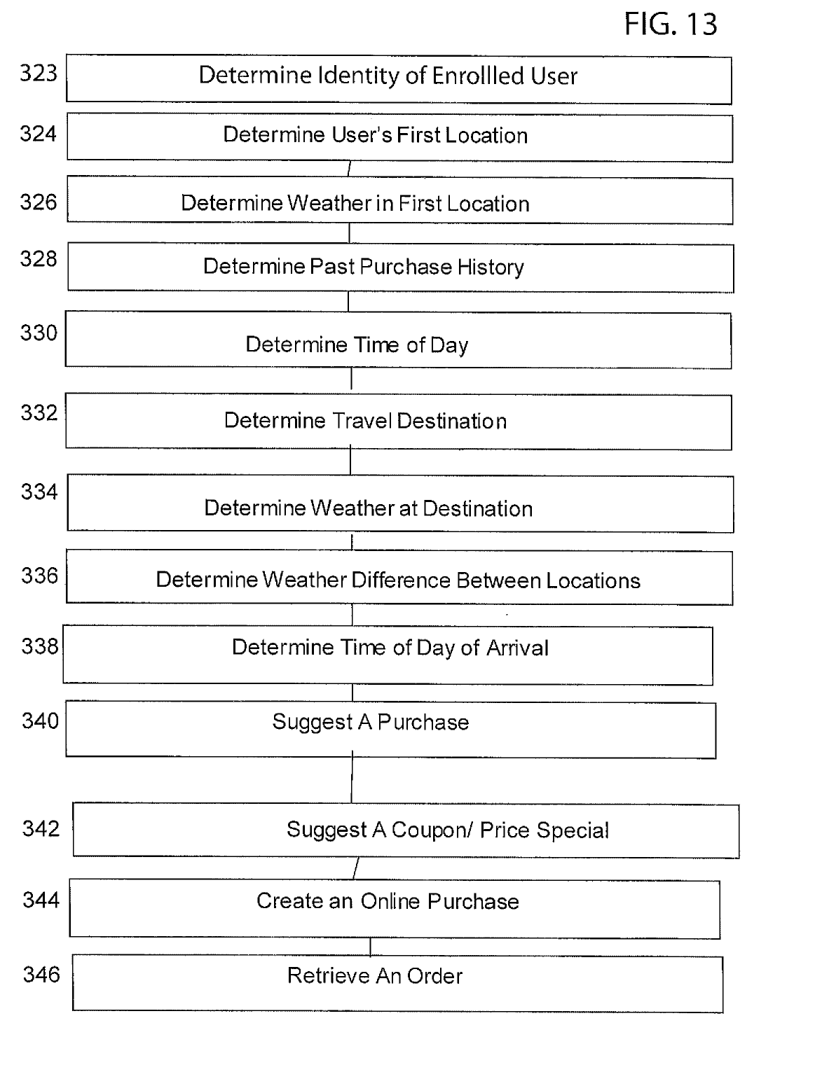

FIG. 13 is a flowchart for the process of another embodiment of the invention. For example, the process can be performed by microprocessor to 21 in application server 201, or can be performed by a microprocessor in any one of the mobile computing devices such as mobile computing device 20 mobile computing device 209 mobile computing device 211, mobile computing device 213, or stationary computing device 215. This process is useful in determining future purchases the user might make if the user is traveling from one location to another. This process can be useful if there are changes in weather from one location to another.

For example, if a user is flying from New York City, in January, and the temperature is 20° F. the user may be traveling to Puerto Rico where the temperature is 80° F. In the approximately 4 hours or more that the user is flying the user will then experience a rapid temperature change. Thus, this process is helpful to determine future purchases that can be made by user based upon the location change and weather change that the user experiences.

The process starts in step 323, wherein the system determines the identity of the enrolled user. This process is similar to that described above in step 302. Next in step 324 the system determines the first location of the user. The system would next determine in step 326, the weather in the first location. For example, in the example list above, if the temperature is approximately 20° F., then that would be considered a cold day. Next, the system would determine in step 328 past purchase history of the user. This would include more recent past purchase history as well as long-term purchasing patterns of the user. Next, in step 330 the system would determine the time of day. Next, in step 332 the system would determine any travel destination. Thus for example, if a user is enrolled in a purchasing program, and that purchasing program has access to the travel plans of the user, then the system can use this travel destination information in this process. This information can be made available to the system, such as to database 202 either by sharing information in another database online or by receiving information from the user about the user's travel plans,

Next, in step 334 the system can determine the weather at the destination location. For example, in the example provided above, if the weather in the destination location is quite warm such as 80 degrees Fahrenheit, the system can determine the likely preferred purchases for the user in that location. In addition, the system can determine in step 336 the weather difference between these locations. Factors such as temperature, humidity, wind, sunlight, can all be used to determine the type of potential purchase the user may wish to make. In addition, the system can determine in step 338 the time of day of arrival. This information can be based upon the travel plans of the user which were presented to the system in step 332. In step 340, the system can suggest a purchase for the user. For example, if the user is in an airport, and the user informs the system that the user is traveling from New York City to Puerto Rico, the system can then inform, or suggest to the user, a purchase prior to boarding a flight. For example, the system can suggest a nice cool drink for the user to purchase in anticipation of arriving at his or her destination. Alternatively, the system could suggest that the user purchase water, if the weather in that location is quite hot. As indicated above, this suggestion can be communicated electronically as described in step 316.

Next, if the user does not decide to purchase an item, the system can in step 342 suggest a coupon or a “special” such as a price reduction on an item. This suggestion can come with a time limit, such that the user can only purchase this item with this specially reduced price or coupon within a preset period of time. Next, in step 344 the user can optionally create an online purchase if the user either agrees with the suggested purchase in step 340 or applies either the coupon or the specially reduced price in step 342. Once the user creates an online purchase in step 344, the system in step 346 can retrieve this order. This type of order/retrieval process can follow the process disclosed in steps 402-422 disclosed in FIG. 16 below.

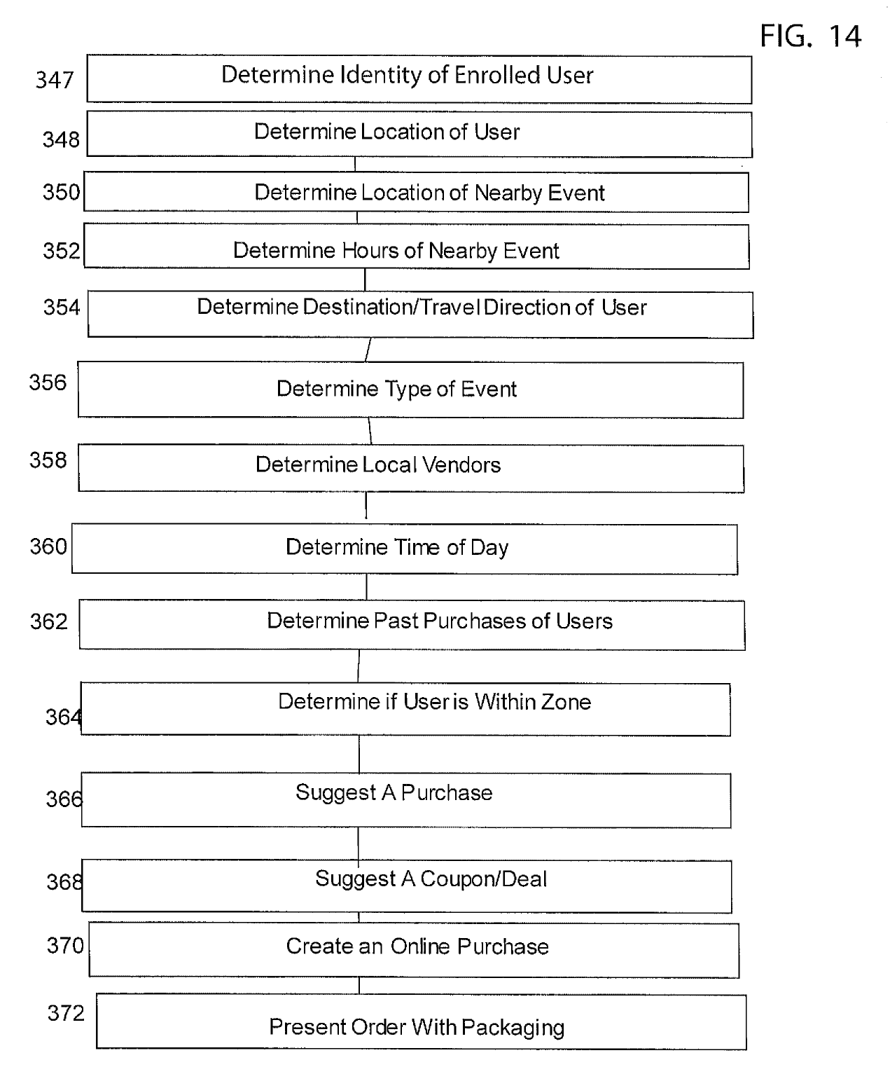

FIG. 14 shows a flowchart for another embodiment of the invention. For example, this embodiment can be used for presenting users with suggested purchases if the user is either traveling to an event, or near a particular event. These types of events could be such as for example sporting events, concerts, a fair, or other type of events such as tractor pulls, a zoo, the circus, or any other type of event. The process can be performed by a microprocessor such as microprocessor 221 and application server 201 by microprocessor 31 in a centralized server 30 or by microprocessor 21 in mobile computing device 24 microprocessor 231 in portable computing devices 209, 211, 213, or in stationary computing device 215. In this case, if these portable computing devices are used to perform the steps, then these portable computing devices or stationary computing device 215 are configured to download a program having the instructions for performing the steps shown in FIG. 14. If these portable or local computers or computing devices 20, 209, 211, 213, or 215, are configured to perform these steps, they are still configured to communicate with a database server such as database server 202 to obtain the necessary database information to perform the steps.

With this process, system starts with step 347 to identify the user which is similar to the step performed in step 302 listed above. Next, in step 348 the system determines the location of the user, wherein this step is similar to the step described in step 304 above. Next, the system can determine the location of the nearby event in step 350. Events such as the Super Bowl, a fair, the circus, can register with this system and provide a location the event, the hours of the event, so that when registered users approach this event or indicate that they are traveling to this event, the system can anticipate future purchases at this event for those enrolled users. Thus, in step 352 the system can determine the hours of the nearby event. In step 354 the system can determine the travel destination of the user. This can be obtained either by the user informing the system of its intended destination or by determining first the location of the user, such as in step 348 and then determining the bearing or heading of the user, and interpreting movements of the user as to whether they are heading towards the event. In step 356 the system is configured to determine the type of the event. For example, if the event is the Super Bowl, this event would be in a first type category such as “sporting events’ or even “Football” which may have particular type customers who are different than those that visit the symphony. Thus users at a sporting event typically wish to purchase different types of items such as food drinks etc. than those that attend the Symphony. For example, if the event is an open-air Symphony concert, users may wish to purchase white wine vs. beer at a football game.

Next, in step 358 the system can determine location of local vendors at the event. Local vendors can sign up with this system, have their identity and location logged into a database in database server 202 so that they can identify a location that they will be positioned in relation to this event. Next, in step 360 the system can determine the time of day for the event. For example, if the event is an evening, users may wish to purchase a dinner type meal, if the event is in the morning such as a sunrise concert, users may wish to purchase a breakfast type meal. Next, in step 362 the system can determine for each user the past purchases of the users. The step is similar to the steps 306, 314 described in FIG. 12. Next, in step 364, the system can determine whether the user is within a zone or region of a point-of-purchase or vendor associated with the event. A zone or region could be a pre-defined area adjacent to a point of purchase which the system is pre-programmed to determine that users within that zone are close enough to make a purchase.

Next, in step 366, the system is configured to determine that based upon the type of the event, time of day, the identity of the user, the weather, past recent purchases, which items should be suggested for purchasing. As described above this suggestion for a purchase is communicated electronically to the user in a manner similar or the same as that of step 316 in FIG. 12. If the user does not make a purchase within a predetermined period of time, the system can then suggest in step 368 a coupon or purchase deal for a reduced price. This step is similar to that of step 318 in FIG. 12 as well. If the user in step 370 creates an online purchase, including payment, then the user can then arrive at his or her destination/point-of-purchase, and be presented in step 372 with the packaging for the order. Alternatively, the user can then pay for the order upon arrival instead of making an online payment transaction. When the user in step 370 creates an online purchase, this information is then forwarded to the point-of-purchase loaded into a point-of-purchase device such as either a black box 70, or a point-of-sale system 80. This information can then be displayed or printed out so that a local vendor can then prepare the order. Alternatively steps 370 and 372 can be performed in a manner described in steps 402-422 shown in FIG. 16.

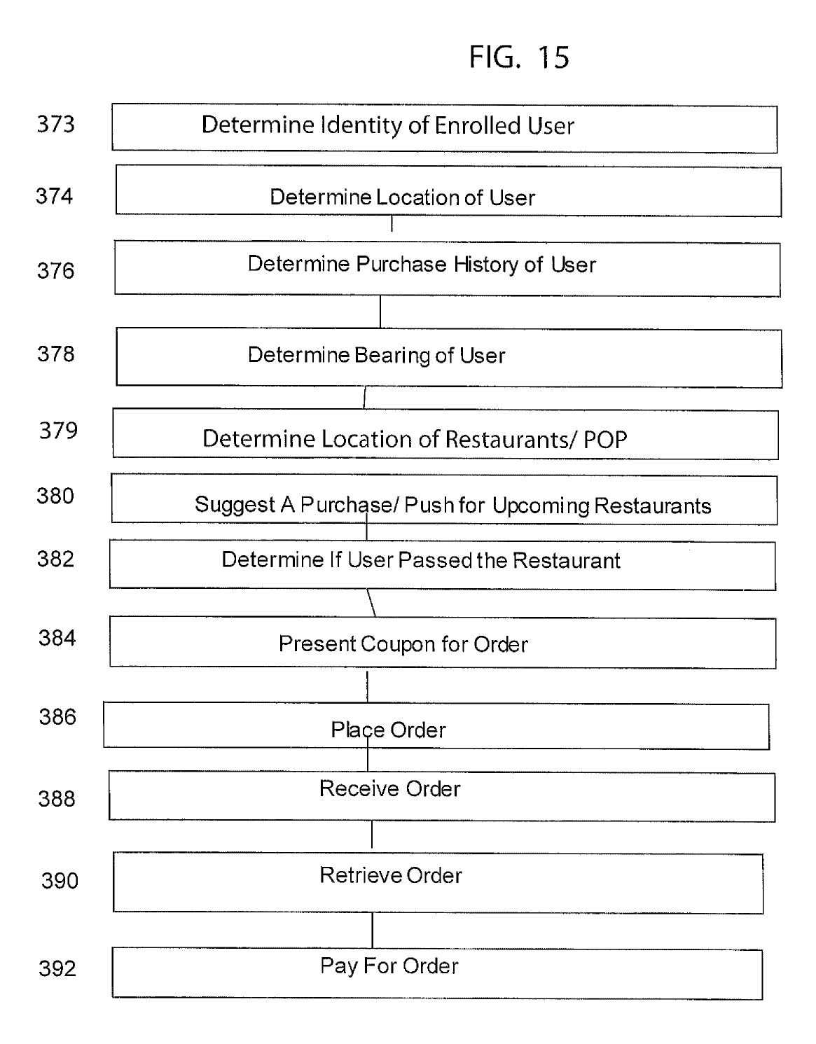

FIG. 15 is a flowchart for another embodiment of the invention. In this embodiment, there is a process for presenting users with information about their favorite restaurants or purchase locations if they are traveling in a particular pattern such as driving down a road. For example, in step 373 the system can determine the identity of the enrolled user. This step can be performed in a manner similar to that of step 302 described above. Next, in step 374 the system can determine location of the user. This step can be formed a manner similar to that of step 304 described above. Next, in step 376 the system can determine purchase history of the user. This step can be performed in a manner similar to that described above in step 306. Next, in step 378, system can determine the bearing or movements of the user. This can be determined by tracking GPS coordinates of the user change GPS coordinates of the user. Once the bearing established, the system, in step 379 can locate local restaurants. Information about these restaurants can be obtained by general information stored by other servers or be obtained by restaurants who enroll with this system and whose information is stored or communicated with database server 202.

Next, in step 380 the system can suggest a purchase or push purchase suggestions to the user. This type of communication is similar or the same as disclosed above in step 316. Next, in step 382, the system can determine if the user has passed restaurant. This is determined by continuously logging the GPS location of the user as the user is travelling. If for example, the user has moved 50 yards, or 100 yards past the restaurant, the system can then present the coupon or a price special for an order in step 384 to the user. This presentation can be in the form of an email, text message, a telephone call, an SMS message, or any other type of electronic notification. Next, the user can, in step 386 place in order. The placement of this order can either be electronically through the users' mobile device or at the location of the restaurant. The placement of this order can include the price special as well as or the presentation of the coupon. Once the restaurant has received this order, in step 388 it can fulfill this order. The user can then in step 390 retrieve this order and pay for this order in step 392. Alternatively, the user can pre-pay for this order in step 386 via an automatic electronic pre-payment as described above. The steps for placing an order and retrieving the order can also be performed in the manner disclosed in steps 402-422 in FIG. 16.

FIG. 16 is another embodiment of the invention, wherein the system is configured to handle multiple orders, to fulfill those orders, and then to present those orders in an organized manner for retrieval by a user/purchaser. For example, the process starts in step 394, wherein this step is performed similar to the manner of step 302 described above. Next, the system performs step 396 wherein the system determines the geographic location of the user. This step is performed a manner similar to that of step 304 listed above. Next, the system determines the location of nearby stores or point-of-purchase in step 398. Thus, the system performs this step in a manner similar to that as disclosed in step 308, but also that presents multiple stores to the user on the user's screen of either their mobile device such as mobile device 20, 209, 211, 213, or on their screen of their stationary device 215. Next, the user can select an individual point-of-purchase or store in step 400. Once an individual point-of-purchase or store is selected, the user can place his/her first order in step 402. This first-order might be an individual order of a sandwich, drink, and a side dish. Next, in step 404 the user can place second-order for second individual such as a sandwich, a drink, and a side dish. In the second-order, the user identifies a separate second user/purchaser for this order, who is separate from the user/purchaser of the first-order in step 402. This way, even if the order is aggregated, the system would know that there are at least two different meals/suborders for at least two different individuals. Next, in step 406 the system can aggregate these orders. The aggregation of these orders allows for the individual payment of multiple orders/suborders as well as the presentation of both these orders at the same time and even in the same location of the point-of-purchase.

Next, in step 408, the order is sent out from the mobile computing device or stationary computing device to the servers. In step 410, the user can optionally send the payment information out to pre-pay prior to when the user picks up the order. In step 412 the system receives the order. With the receipt of this order, the information relating to the order and the purchase information is uploaded into either black box 70, point of sale computer 80 or communication computer 90. Next, in step 414 the system can fulfill each individual order. This occurs by a server forwarding this purchase information onto a black box 70, a point-of-sale, 80 or local communication computer 90, so that a point-of-purchase location or restaurant can fill the order. When fulfilling the orders in step 414, system can identify the identity of the order and each suborder or meal associated with the order. Thus, the computer such as black box 70, or point of sale computer 80 at the point-of-purchase can de-aggregate the order based upon this information. With this information, the point-of-purchase location can print a label for either an individual order, a suborder, or even an individual item in a suborder, or in an individual order. The labels are then placed on the appropriate items of these orders.

When a purchaser retrieves his or her order at the point-of-purchase location, the user can then receive an organized order, with identification labels on each item, or on each bag separating each suborder, and identifying for each individual, their particular order or their particular item. The user can also receive an itemized receipt in step 420 itemizing each individual item, separating out each suborder, from the entire order, to make it easier for a purchaser to retrieve payment from other users. Next, in step 422 the system can then record this purchase information, and store this information in a database such as database server 202. This person purchase information can then be logged for future reference, so that system can then determine future likely purchasers of the user.

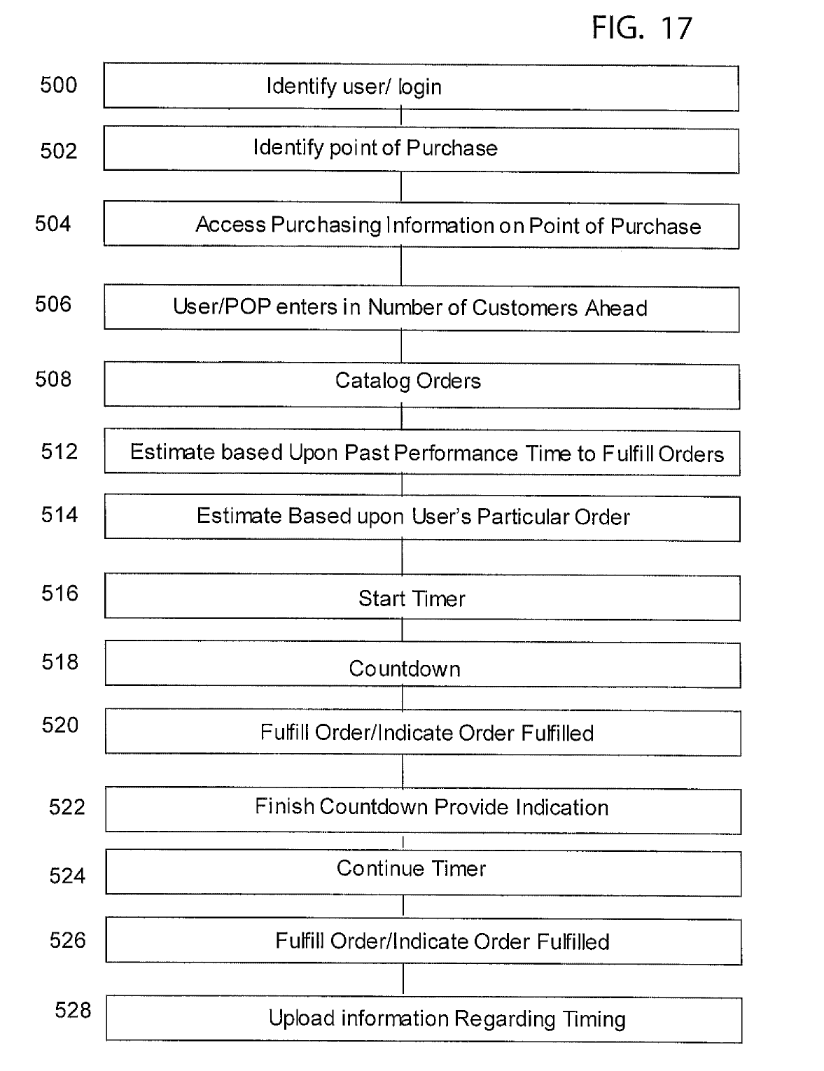

FIG. 17 discloses a new embodiment of the invention, which includes a process for determining for user the time for fulfilling an order. For example, in step 500 the user can provide his or her identity. This step is similar to the process described in step 302 in FIG. 12. Next, in step 502 the user can identify the point of purchase location. With this step, the user can communicate with a server such as server 201 indicating the GPS location of the user. Server 201 can then match the GPS location of the user to the location of a known point-of-purchase location such as a restaurant.

Next, in step 504, the user using his mobile device such as device 20, 109, 111, 113 can access purchasing information associated with the point-of-purchase location. This information can be downloaded from servers such as centralized server 30 or servers 201/202. During this step, the user can access the profile for the point-of-purchase.

Next, in step 506 the system can receive information entered by the user or the controller at the point-of-purchase regarding the amount of customers in the location. For example, from the perspective of the user, the user can enter in the number of customers who are ahead of the user at that location. From the point or perspective of the point-of-purchase controller, the controller can enter the number users in that location. This information can then be uploaded to a server such as server 30 or server 201 and stored in server 202. Next, in step 508, a server such as server 30 or server 201 catalogs the orders that have been placed, or that are expected to be placed in the near future. Next, in step 512, the system which can be in the form of the mobile computing device 20, 109, 111, 113, or 115, or alternatively server 30 or server 201 can provide an estimate for time to fill the order based upon the past performance of the point-of-purchase, and the average time to fill these orders. This step is performed using either the microprocessor in server 201 which can be microprocessor 221, the microprocessor 31 in server 30, or performed using microprocessor 21 or 231 in any one of mobile computing devices 20, 109, 111, 113, 115.

Next, in step 514, the system can determine the amount of time necessary to fill that users particular order. For example, in some stores, or point-of-purchase, a single order of coffee may put in a different line then a large order of a full meal, or more complicated orders. Therefore, the estimated time can be dependent upon the type of order that the user places. Next, the system can start a countdown timer in step 518. If server 30 or 201 starts countdown timer, this information is then relayed to any one of the mobile computing devices 30, 109, 111, 113, held by the user. If, before the countdown timer finishes a user or point-of-purchase controller fulfills the order in step 520, then this information can be b relayed to a server such as server 30 or server 201, or individually communicated to portable computing devices 20, 109, 111, 113, or computing device 115.

Alternatively, in step 522, if the order is not filled before the countdown timer finishes, then the countdown timer ends and provides an indication that the order took longer than the estimated time. In step 524, the timer can continue past the estimated time until the order is filled in step 526. Indication of the order being filled will be provided to server 201, or to any one of the portable computing device as disclosed in step 522. Next, in step 528, information of this transaction including the timing information is uploaded to server 201 so that this information can then be used for future analysis and future estimates for timing countdowns.

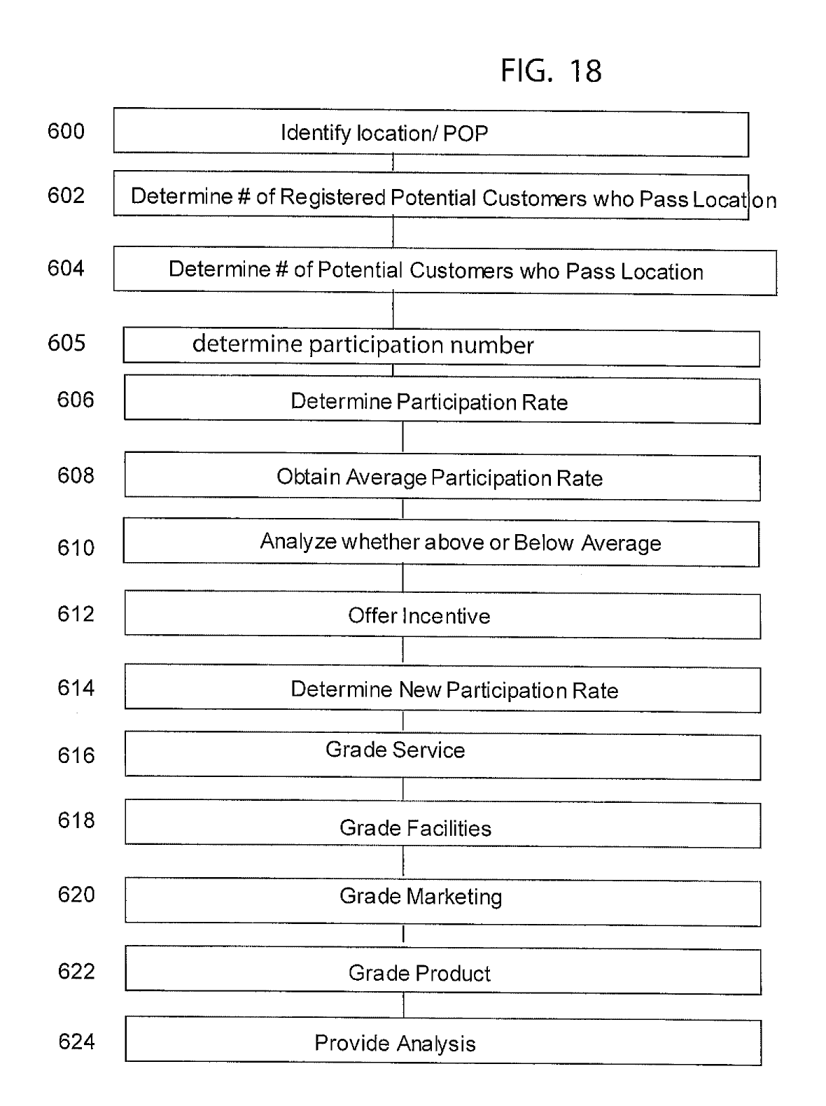

FIG. 18 is another embodiment of the invention which involves a process for determining service quality, the facility quality, the marketing quality, and the product quality of a restaurant or point-of-purchase. The process can be performed by a server 30 using microprocessor 31 or an application server 201 using processor 221 or by microprocessor 231 in portable computing devices 209, 211, 213, or in stationary computing device 215. In this case, if these portable computing devices are used to perform the steps, then these portable computing devices or stationary computing device 215 are configured to download a program having the instructions for performing the steps shown in FIG. 18. If these portable or local computers or computing devices 20, 209, 211, 213, or 215, are configured to perform these steps, they are still configured to communicate with a database server such as database server 202 to obtain the necessary database information to perform the steps.

The process starts in step 600 wherein the system such as server 30 or 201 identifies location of the point-of-purchase or restaurant. With this system the point-of-purchase location or restaurant can enroll in this analysis or study to determine whether the point-of-purchase location or restaurant meets a sufficient quality level. Thus, step 600 can include not only identifying the location, but also enroll a new location in this study. Next, in step 602 the system determines number of registered customers who pass a particular location. For example if customers or users have registered with this system and can be tracked with respect to their location relative to the location of this point-of-purchase location, the system can then track how many registered users or potential customers pass or arrive at that particular location. This number once obtained can be compared to actual observed data or extrapolated to determine a total number of potential customers who pass a location.

Next, in step 605 the system can determine a total estimated participation number for users or potential customers who pass particular location. This is taken from the first estimate provided in step 602 and the number of actual registered users in step 604. Next, in step 606 the system can determine the participation rate of the users or potential customers based upon the number of orders taken by that point-of-purchase location. This is determined by the point of purchase informing the system (server 30 or server 201) of the number of customers handled over a particular sample time period. This step can be performed by providing a sales log for that location.

Next, in step 608, the system such can obtain the average participation rate across all relevant point of purchase locations from the historical log of participation rates for all of the participating point-of-purchase locations. For example, if the point of purchase is a franchise restaurant, the system can compare the actual participation rate of that location to the average participation rate with respect to a plurality of comparable franchises who have registered with the system. Next, in step 610, the system can analyze whether that individual point-of-purchase location is either above or below average in participation. Depending on the level of participation, and how far off that point-of-purchase location is from a historical average, the system can offer sales incentives in step 612. The sales incentives can be pushed to potential customers in the form of electronic messaging or notifications on a user's installed “app” on their mobile computing device.

Thus, in this step, a server such as server 30 or server 201 could push electronic communications out to all participating or registered potential customers who are within a particular geographic region of that participating point of purchase to offer incentives such as coupons, or short term pricing deals to get these potential customers to make purchases in this point-of-purchase location. Next, after preset period of time, after the initiation of these incentives, the system can then determine a new participation rate. After the system determines the new participation rate in step 614, it can analyze whether this new in participation rate is higher, and whether this rise in participation rate meets projected targets. Next, the system can then grade different features of the point-of-purchase location to determine whether these incentives offered in step 612 are sufficient alone, or whether the point-of-purchase location needs to make changes.

For example, in step 616 the system can grade the service of the location. The grading of the service of this location can be based upon the wait times for fulfilling orders such as that disclosed in FIG. 17, or based upon a survey of the type of service that users perceive is provided by the point-of-purchase. Next, in step 618 the system can grade the facilities of the location. This can include the cleanliness, lighting, location, access, seating, and other features associated with the physical structure and the upkeep of this point-of-purchase location. Information relating to this grade can be inserted either by current or former customers, via a survey or via an on-site review by an impartial judge. This information can then be uploaded to the system such as to central server 30 or to server 201 or to database server 202. Next, the system in step 620 can grade the marketing of this point-of-purchase location. This marketing can be graded based upon questions presented to current and former customers of this location to determine whether these customers receive promotional materials, recognize the sign for the location, recognize local advertising from location or any other type of marketing information. This information can then be uploaded into server 30 or to server 201 and then stored in database server 202. Next, in step 622 the system can grade the product provided by the point-of-purchase. For example, this would be a grade of the quality of the food presented in the restaurant or fast food establishment. This grade can be taken by providing a survey to current and former customers of the quality of the food or drinks presented to these customers. Questions presented to these users could be related to both taste of the food, and the quality of the cooking of the food, or any other feature associated with the taste or presentation of the food. This information can then be uploaded to system such as to server 30 or to server 201 and stored in database server 202. Next, in step 624 the system provides an analysis of these different grades as well as an analysis of the participation rate both before and after the offering of incentives. From this analysis, the system can then provide instructions on how to change the quality of the service, the quality of the facilities, the quality of the marketing, and the quality of the product produced for this point-of-purchase location. This analysis can be performed by microprocessor 31, in server 30 or by microprocessor 221 in server 201.

Accordingly, while at least one embodiment of the present invention have been shown and described, it is to be understood that many changes and modifications may be made thereunto without departing from the spirit and scope of the invention as defined in the appended claims.

What is claimed is:

1. A computing system comprising:
a) a mobile computing device having a processor programmed to take a plurality of food orders and programmed to aggregate these food orders into a single scannable source of information comprising a 2d barcode;
b) a scanner configured to read this scannable source of information;
c) a microprocessor which is configured to read from the scanner a scanned aggregated order at a point of purchase location, wherein said microprocessor is programmed and configured to de-aggregate an order from this scanned communication;
d) a transceiver which is configured to send this de-aggregated information; and
e) a point of sale computing device having a processor configured to read this de-aggregated information and to ring up a scanned aggregated order to create an order for a purchase.

2. The computing system as in claim 1, wherein said mobile computing device is a telephone.

3. The computing system as in claim 1, wherein said scanner is a barcode scanner.

4. The computing system as in claim 1, wherein said scanner is a near field scanner.

5. The computing system as in claim 1, wherein said scanner is coupled to said point of purchase location.

6. A computerized process for processing an order for a restaurant comprising the following steps:
a) determining an identity of an enrolled user;
b) determining a location of the enrolled user;
c) determining a past history of purchases for the enrolled user;
d) determining a location of a point of purchase;
e) suggesting a purchase to the enrolled user;
f) receiving an order from the enrolled user;
wherein the step of suggesting a purchase comprises determining via a microprocessor a likely purchase order based upon an identity of the user, the location of the user, the past purchase history of the user, and the location of the point of purchase an presenting said suggestion to the enrolled user.

7. The computerized process as in claim 6, wherein said step of determining a location of an enrolled user comprises accessing the positioning coordinates of the user.

8. The computerized process as in claim 7, further comprising the step of determining a weather condition in said location of said enrolled user.

9. The computerized process as in claim 8, further comprising the step of determining a time of day before suggesting a purchase, and wherein said step of suggesting a purchase comprises suggesting a purchase based upon the identity of the enrolled user, the location of the enrolled user, the past purchase history of the enrolled user, the location of the point of purchase, the weather condition, at the location of the enrolled user and the time of day.

10. The computerized process as in claim 9, further comprising the step of electronically transmitting a coupon for a user for a purchase and displaying said coupon on a remote computing device.

12. The computerized process as in claim 11, further comprising the step of performing an electronic purchase of said suggested purchase and transmitting funds to compete said electronic purchase.

13. The computerized process as in claim 12, further comprising the step of determining a travel destination for said enrolled user, before said step of suggesting a purchase, and calculating via said microprocessor said suggested purchase based upon said travel destination for said enrolled user.

14. The computerized process as in claim 12, further comprising the step of determining a location of an event located in a predetermined location zone of said enrolled user, by determining a location of said event, determining a location of said enrolled user, and determining whether said enrolled user is located within said predetermined location zone of said event.

15. The computerized process as in claim 12, further comprising the step of determining if said enrolled user passed said location of said point of purchase.

16. The computerized process as in claim 15, wherein said step of electronically transmitting said coupon occurs after said step of determining if said enrolled user passed said location of said point of purchase.

17. A computerized process for analyzing a quality of a point of purchase location comprising the steps of:
a) identifying a location of a point of purchase;
b) determining a number of potential customers that pass said location of said point of purchase and storing said information in a database;
c) determining a number of registered potential customers that pass said location of said point of purchase, by reading a set of positioning coordinates of said registered potential customers;
d) determining a number of customers who purchase items from said point of purchase by reading a sales log;
e) determining a participation rate using a microprocessor by dividing said number of actual customers by said number of potential customers;
f) offering an incentive for a purchase to a plurality of said registered potential customers; and
g) determining a new participation rate for said customers using said microprocessor, comparing said number of actual customers to said number of potential customers.

18. The computerized process as in claim 17, further comprising the step of grading at least one quality of the point of purchase comprising at least one of: service, marketing, product, and facilities.
